(19) United States
(12) Patent Application Publication
(10) Pub. No.: US 2007/0136105 A1
(43) Pub. Date: Jun. 14, 2007

(54) Insuring decisions within an organization

(76) Inventors: Bernardo Huberman, Palo Alto, CA (US); Tad Hogg, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/297,866

(22) Filed: Dec. 9, 2005

(51) Int. Cl. G06Q 40/00; G05B 19/418; G06F 15/02

(52) U.S. Cl. 705/4; 705/8; 705/9

(57) ABSTRACT

Provided are systems, methods and techniques for insuring decisions within an organization. In representative implementations, project insurance is provided to an individual working on a project for an organization. The project insurance has (i) a payout event that is defined as a failure of the project to meet a specified criterion pertaining to success of the project and (ii) an associated payout benefit. The payout benefit is provided to the individual under the project insurance in the event that the payout event occurs.

### FIELD OF THE INVENTION

The present invention generally pertains to employee compensation techniques and is particularly applicable to techniques for adjusting employee risk in order to align the employee's interests more closely with that of the employer.

### BACKGROUND

In many cases, an employee's interests diverge from those of his or her employer. Various compensation schemes have been attempted in order to address this divergence and to bring the interests of employee and employer more in line. However, each such scheme has its own deficiencies, and none adequately solves certain problems addressed by the present invention.

### BRIEF DESCRIPTION OF THE DRAWINGS

FIG. 1 is a block diagram illustrating coverage under a project insurance program according to a representative embodiment of the present invention.

FIG. 2 is a flow diagram for explaining a method of implementing project insurance according to a representative embodiment of the present invention.

FIG. 3 is a block diagram illustrating certain examples of how additional oversight employed in connection with project insurance is performed according to a representative embodiment of the invention.

FIG. 4 is a block diagram illustrating relationships between the project insurance program and other entities within the organization, from an overall organizational perspective, according to a representative embodiment of the present invention.

### DESCRIPTION OF THE PREFERRED EMBODIMENT(S)

The present invention is directed to systems, methods, techniques and structures by which an employer may more closely align its employees' interests with its own, particularly where the employees' attitudes toward risks are involved. For example, when faced with a decision whether to implement a safe project or a risky one, a manager might well choose the safe one even if that manager believes the riskier one has a higher potential expected benefit to the company which more than offsets the additional risk. Such a choice might be made, for example, because the manager is unwilling to risk the negative effects on his or her compensation, or the other negative professional effects, that might arise if the project fails. The alignment of interests between employee and employer in this regard often can lead to a more satisfied and fulfilled workforce, because the employees become more willing to undertake projects in which they believe while simultaneously having available an option to reduce their personal risk exposures. Higher worker morale and corresponding increases in productivity typically should result.

Also, in many instances the individual manager or other employee often is not able to accurately gauge risks and expected returns in a realistic manner. This inability similarly might be influenced to some extent by the individual's own interests. In any event, the systems and structures of the present invention often can elicit better information in this regard.

Finally, the systems, methods, techniques and structures provided by the present invention often provide additional benefits for an employer. Examples include: better information about the amount and type of risk associated with individual projects, increased ability to control its risks and to make informed decisions regarding individual projects, and enhanced assessments of its employees. Moreover, implementation of a project insurance program in accordance with the present invention can in certain cases result in a paradigm shift toward more realistic attitudes regarding project risk and toward more outcome-based performance evaluations that independently can provide a net benefit to the company.

In this regard, organizations often face a problem of risk aversion on the part of decision-makers and other employees, particularly when compensation is tied to individual performance. This results in people making more conservative choices even when those choices result in a lower expected return to the organization than could be achieved if riskier decisions were made. The present invention provides an insurance mechanism, compensating managers and employees for failed outcomes. In addition, the present invention provides techniques to address the potential moral hazard that this kind of insurance otherwise would generate.

A properly designed decision-insurance mechanism can be readily implemented within organizations so as to increase the likelihood that managers will behave in the best interests of the enterprise, even when they are risk averse. In addition, representative embodiments the present invention use the social network of the manager or other employee to help reduce the moral hazard inherent that otherwise might be inherent in connection with such insurance. Preferably, this is accomplished by automatically identifying the community of practice around a given manager or other employee from patterns of e-mail exchanges within the organization. From this community of practice, a monitoring group preferably is established.

It should be noted that the present invention is particularly applicable to managers, but also is applicable to any other employees, particularly those who are compensated and/or evaluated based on their performance or, more accurately, the results of their performance. Thus, whenever the term “manager” is used herein, it should be understood that such use is exemplary only, and the same considerations and concepts apply to other types of employees within the organization as well.

Project Insurance Implementation

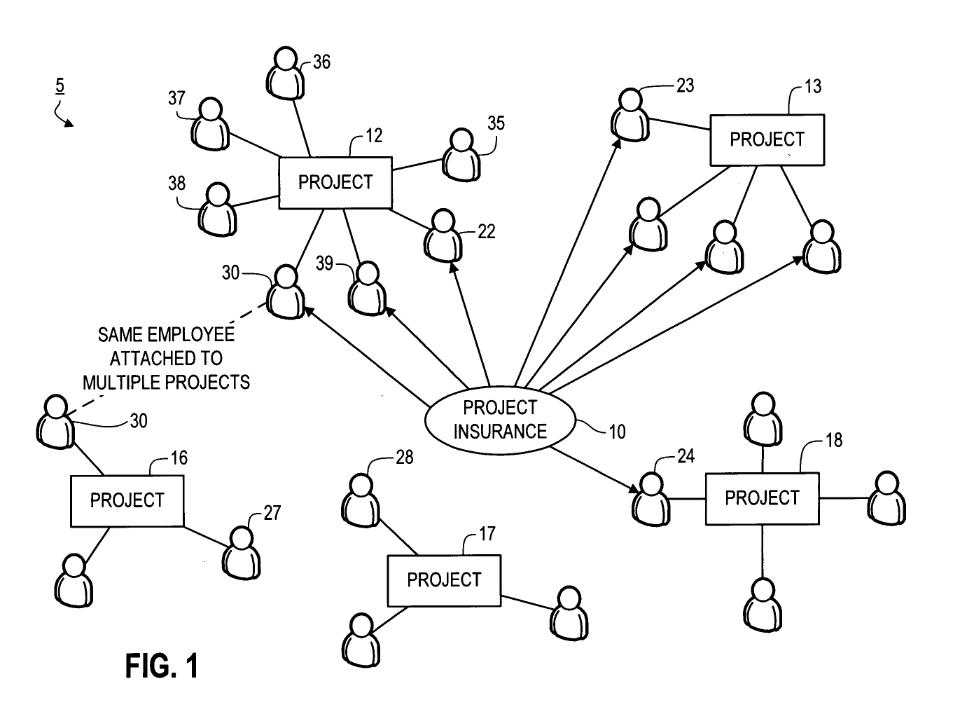

FIG. 1 is a block diagram illustrating coverage within an organization 5 under a project insurance program 10 according to a representative embodiment of the present invention. In the preferred embodiments of the present invention, an organization 5 creates and maintains a separate project insurance program 10 that provides insurance to its employees (e.g., employees 22-24) to cover risks of working on projects that are perceived to be risky (e.g., projects 12, 13 and 18). It is noted that in alternate embodiments, the project insurance program 10 is run by an entity that is distinct from organization 5.

More specifically, FIG. 1 depicts a number of projects 12, 13 and 16-18 undertaken by the organization 5 (the employer). Each project 12, 13 and 16-18 has a number of employees that are assigned to work on it, with the employees assigned to each project indicated by the plain solid lines in FIG. 1. For example, project 12 has employees 22, 30 and 35-39 assigned to it. As noted above, some of the organization's employees are covered by insurance provided by project insurance program 10. In FIG. 1, these covered employees are designated by solid arrow lines from project insurance program 10 to them and include, e.g., employees 22-24.

However, as indicated in FIG. 1, not all employees are covered by the insurance (e.g., employees 27 and 28 are not) and not all projects have employees assigned to them that are covered. Rather, as discussed in more detail below, the insurance preferably is provided only for the riskier programs and only at the request or option of the individual employees.

Thus, in the example shown in FIG. 1 only about half of the employees associated with project 12 are covered by project insurance, all of the employees associated with project 13 are, only one associated with project 18 is, and none associated with project 16 or 17 is. As coverage preferably is optional, this might indicate: (i) that the employees consider the projects to have different levels of riskiness, (ii) that certain projects have more risk-averse employees working on them, or (iii) some combination of these situations. One significant advantage of the present invention is that the project insurance program 10 preferably is made flexible enough to accommodate a wide variety of different situations and different individual employees.

It should be noted that in alternate embodiments of the invention, the project insurance is mandatory to some extent. For example, in one embodiment all employees are required to be covered. In another, all employees assigned to the riskier projects are required to be covered.

In certain cases, a single employee 30 is assigned to two or more different projects 12 and 16. In such a case, the present invention provides for the possibility that the employee 30 is provided with insurance coverage with respect to his or her participation in one project 12 but not the other 16.

In the preferred embodiment of the invention, the project insurance program 10 is operated directly by the company 5. Moreover, as discussed in more detail below, the project insurance program 10 preferably is operated on a profit-maximization basis, evaluating risks, assessing insurance premiums and paying out proceeds in as efficient a manner as possible so as to become a profit center for the operation 5.

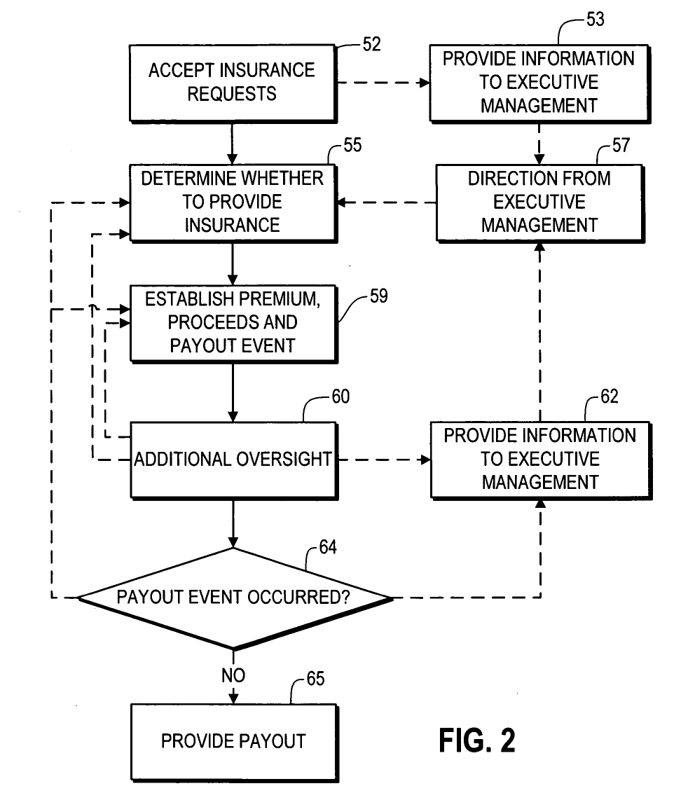

FIG. 2 is a flow diagram for explaining a method of implementing project insurance according to a representative embodiment of the present invention. In FIG. 2, the solid arrow lines indicate the flow of the process, while the broken arrow lines indicate flows of information.

Initially, in step 52 insurance requests are received from various employees of the employer/organization 5. Typically, with respect to a particular project, such a request initially is received from a project manager who becomes aware of an opportunity to pursue a potential project that he or she believes has a high expected return for the company 5. However, due to the personal risk to the manager, in terms of lost actual or potential compensation (e.g., because the manager has an incentivized results-based compensation plan) and/or due to other non-monetary professional considerations, the manager is reluctant to pursue the potential project. In addition, or instead, the initial requests for project insurance might come from other employees who are considering working on the potential project or who are requested to work on the project, but who believe that their personal risk would be too high without such insurance.

It is noted that requests for project insurance in this step 5 may occur at any point during the life of the project, from initial conception until the later stages of the project, whenever a manager or other employee is considering participating in the project. In addition, in certain embodiments of the invention employees are permitted to request and/or obtain project insurance according to the present invention even after they have begun working on the project, e.g., when other opportunities for an employee arise within the company and the employee is required to make a choice to stay on the existing project or transfer to another.

Typically, however, project insurance according to the present invention only will be available or sought for projects that are considered to be fairly risky. Accordingly, while such insurance might be requested in the earlier stages of a project, as the project becomes more mature and the associated risk declines, the need for project insurance with respect to it will decline correspondingly.

It should be noted that in the present embodiment project insurance is available only upon request from an employee. This provides maximum flexibility with respect to individual employees. For example, different employees have different levels of risk aversion and might have different compensation packages with differing relative portions based upon individual results. Therefore, when presented with the same opportunity, different employees often will respond differently. By providing employees the opportunity, but not the requirement, to obtain such insurance, it is believed that individual personalities and situations are accommodated to the greatest extent possible. However, in other embodiments the organization 5 has the option to initially propose such insurance to the employee. In still further embodiments, the organization 5 makes such insurance mandatory, at least with respect to certain designated projects.

One consideration that potentially favors mandatory insurance is the well-known problem of adverse selection. In the insurance context, this problem arises in situations where there is asymmetric information, typically meaning that the potential insureds have more knowledge than the insurance provider. By providing a single rate to all prospective insureds (or by not adequately differentiating), the potential insureds who will benefit most by acquiring insurance will be more likely to seek it, often driving up costs for the insurance provider and eventually resulting in higher premiums. The increase in premiums often leads more individuals to conclude that the insurance is not worthwhile and, therefore, to drop it. The two most common solutions for addressing this problem are to make insurance mandatory, in which case risk is spread across the entire population, or to price the insurance differently based on appropriate characteristics of the prospective insureds. Unfortunately, the former approach eliminates a significant amount of flexibility. The latter approach is discussed in more detail below.

As will become apparent throughout this disclosure, in addition to operating as an insurance entity, program 10 preferably also serves a function of providing information to senior management. One example is the provision 53 to senior management of information regarding the requests for project insurance made by employees.

This information preferably then is assessed by senior management in determining the actual amount of risk associated with proposed projects. Although a lower-level manager typically will present some estimate of the risk associated with a project, the manager might be biased or simply incorrect in his or her assessment. For example, a manager might become strongly attached to a potential project, clouding his or her judgment and causing him or her to underestimate the actual risks, or to overestimate the potential benefits of the project. In such a situation, a company's senior management traditionally would have had little choice but to rely upon the opinion of the manager proposing the project, as the manager usually is the person most familiar with the details pertaining to the project.

However, in accordance with the present invention, the number of requests for project insurance often will provide additional information about the riskiness of the project. For example, if a large number of requests for project insurance come from employees who have been asked to participate in the proposed project, senior management might determine that others in the company, who also are very familiar with the details of the project, have reached the conclusion that the project is riskier than the manager has estimated. Based on such information, senior management might decide to investigate further and, ultimately, eventually decide to override the manager's judgment, or at least alter internal projections in accordance with the new insurance-related information.

In certain embodiments of the invention, the employee may request or obtain different levels of insurance, each requiring a different premium and transferring a different amount of risk from the individual employee to the insurance program 10. As a result, the employee is provided with enhanced flexibility in designing his or her own risk profile.

Next, in step 55 a determination is made as to whether or not to issue the requested project insurance. In certain embodiments of the invention, project insurance is provided for any employee working on a project that is deemed sufficiently risky. In others, the decision to provide insurance is made on an individual basis. For example, in one embodiment insurance is only provided if a sufficient number of employees on the project request it. In another, insurance is declined if the employee's past history indicates a pattern of free riding or otherwise suggests that the modified incentives resulting from the provision of project insurance are not appropriate for that requesting employee. Also, in certain circumstances executive management might instruct 57 that the project is not going forward or that insurance is not to be provided for this particular project (e.g., in either case based on information provided to it by the project insurance program 10).

In step 59, the project insurance program 10 establishes the premium, proceeds and payout events for the requested insurance. It is noted that in the preferred embodiments of the invention the premium for the project insurance is deducted from the insurance proceeds or from the additional compensation paid to the employee in the event that the project is successful. However, in alternate embodiments, the premium is paid upfront by the employee.

Preferably, both the premium amount and the payout proceeds are based on characteristics of the project (e.g., riskiness) and data pertaining to the requesting employee (e.g., past history, current and/or anticipated future compensation, including base salary and/or bonus). Generally speaking, all things being equal, a riskier project will require a higher premium to compensate for the likelihood that a payout will have to be made. As to the requesting employee, a number of factors preferably are taken into consideration.

The first employee-related factor arises out of the potential problem of adverse selection, mentioned above. In the present context, one possibility is that managers or other employees who do not have a high degree of confidence in the proposed project will be more likely to seek project insurance under program 10. Even this generally is only a problem to the extent that such employees have better information than the insurance program 10, which would result in the program 10 underestimating the likelihood of failure and ending up having to pay out more than it anticipated.

One potential solution to this problem is to set the premiums and the payout amounts at levels such that the employee could not be better off if the project failed and he or she were to receive the insurance proceeds than if he or she worked on a different (e.g., safer) project. Such a solution also would tend to address the moral hazard problem (discussed in more detail below) by giving the employee the maximum incentive to work hard to ensure that they project succeeded, if he or she in fact elected to work on it. For such a solution to work, however, the organization 5 generally would need to ensure that the subject employee actually has a meaningful choice about whether or not to work on the project. A second way to address this problem is to obtain sufficient information to price the premiums appropriately to the actual risk level of the project. With respect to this solution, as noted above, the number or percentage of employees seeking insurance in connection with the project preferably is considered in determining how risky the project really is.

Another aspect of the moral hazard problem is that the lazier or less competent employees might be more inclined to seek opportunities in which their performance level is not as great a factor in their overall compensation, including seeking project insurance, which effectively insures against failure. To address this problem, the employee's premium preferably is based on the specific track record of the requesting employee. In addition, the moral hazard protections described below generally will tend to mitigate this problem to some extent.

Beyond adverse selection problems, the specific compensation package of the individual employee (e.g., both base salary and bonus, together with anticipated increases in each if the employee instead were to work on a safe project) preferably is considered when setting the employee's premium. In this regard, assuming that the project is in fact worthwhile from a risk/benefit assessment, then the premium and payout amounts should be set such that the amount of risk to the employee is reduced to an acceptable level that would encourage the employee to work on the riskier project. For example, assume that an employee can expect a year-end bonus if he or she works on a safe project of $5,000 and, if he or she works on a risky projects, either 0 (if the project is unsuccessful) or $20,000 if the project is successful. In such a case, the net payout to the employee in the event of failure (i.e., actual insurance proceeds less insurance premium) might be set at $3,000-4,000, so that the employee has some potential net loss in the event the project fails, with the net benefit if the project succeeds being the $20,000 bonus, less the amount of the insurance premium required to be paid by the employee.

Another factor in setting the amounts of the premium and the insurance proceeds is that insurance program 10 preferably is charged with maximizing its own profit. Accordingly, the program 10 preferably has some motivation to assess premiums accurately to reflect the true risk of the project's failure.

Needless to say, in many situations some of the foregoing factors will conflict with each other to some extent. However, a proper balance ordinarily can be achieved in any situation where the project is in fact expected to provide an overall positive return, particularly if such expectation is satisfied even after factoring in a premium for the increased risk assumed by the organization 5. One situation in which a balance might not be possible is where the employee's compensation package is structured such that the project does not in fact make financial sense for the employee to undertake, even if one assumes a purely risk-neutral approach. That is, even if the project provides a net expected benefit for the organization 5, if for some reason the employee does not adequately share in the expected benefits in the event the project is a success (e.g., so that the expected benefit to the employee actually is higher with the safer project), then it generally will not be possible both to provide adequate employee incentives through insurance and to operate product insurance program 10 in a profit-maximizing manner. In such a case, the organization 5 might want to reevaluate the incentives provided in the employee's compensation package or, as discussed in more detail below, provide separate cash transfers to program 10 to subsidize the insurance.

The final determination in this step 59 is when to payout of the insurance proceeds. In certain embodiments, there will be only a single payout event with a single triggering criterion (which potentially has multiple different aspects). However, in other embodiments multiple payout events are accommodated. For example, a risky project might last for several years before results can start to be seen. In the meantime, if the employee's compensation package has a significant results-based component, then the employee might be foregoing raises and/or bonuses for an extended period of time if the insurance requires the employee to wait until success or failure of the project can be determined with any degree of certainty. To address this problem, in certain embodiments the insurance provides for periodic payments under specified conditions, e.g., the project is still ongoing, the employee is still working on it a specified minimum percentage of his or her time and the employee's efforts on the project are judged to be adequate, with a final payment when the main success criterion can be properly evaluated.

The primary event for releasing the insurance proceeds with respect to such project insurance preferably is that the project fails to satisfy a specified commercial success criterion. In this regard, commercial success preferably is defined in a number of different ways in the various embodiments of the present invention and/or in various instances of the insurance in any given embodiment. For example, in one instance the commercial success criterion is that the project earns a specified amount of profit by a specified date. In another instance, the criterion is that the project creates a specified amount of positive publicity for the organization 5. In another instance, the criterion is that the project results in a minimum sales volume by a specified date. In a still further instance, any combination of the foregoing factors constitutes the commercial success criterion. Finally, it should be noted that in certain embodiments of the invention, and/or different instances of the insurance within a given embodiment, different commercial success criteria are defined, with a different payout amount for each one. As noted above, the payout amounts preferably are tied to the employee's compensation structure so as to provide adequate incentives, both in terms of risk reduction to encourage the employee to initially decide to work on the project and also in terms of motivating the employee to work hard on the project in an effort to achieve its success.

In certain instances of the project insurance hereunder, one aspect of the payout event is that the failure of the project was not related in any substantial manner to the employee's own lack of effort. A determination in this regard preferably is based at least in part on the additional oversight discussed below. In alternate embodiments, the payout amount is reduced if justified by the employee's lack of effort.

Finally, the payout proceeds of the project insurance hereunder is fixed in certain embodiments of the invention. In other embodiments, it is based on (e.g., a percentage of) the profits or other successes of other projects (e.g., only other risky projects and/or her only other projects in the same division) within the organization 5.

In step 60, additional oversight of the insured employee's efforts occurs during the course of the project. Such additional oversight generally is desirable in order to address the potential moral hazard problem that otherwise would arise. That is, at least some individuals likely will change their behavior because they no longer bear the full cost of their decisions and efforts. In the present context, such a problem can arise in connection with the effort that managers exert into evaluating the likelihood of given outcomes or with the efforts of any employees working on the project. With compensation no longer tied as closely to the success of the project's results, there is a temptation to work less and thus suffer only a small decrease in individual compensation, i.e., free ride on the effort of others in the organization 5. Even if employees do not actually follow such a strategy, the appearance of a conflict of interest caused by insurance could inhibit its widespread adoption, and thus prevent the organization 5 from realizing its potential for improved results from increased risk-taking.

The foregoing free-riding problem preferably is addressed through additional oversight. In an organizational context, managers provide some level of performance monitoring but, for example, might not be in a position to know whether outcome likelihoods used to make decisions are accurately estimated or simply determined arbitrarily in the knowledge that the insurance mechanism will compensate for any failures.

To improve the accuracy of decisions (and by implication a substantial effort on the part of decision makers), the ordinary management oversight preferably is supplemented with additional oversight for insured managers and other insured employees. More preferably, such additional oversight takes the form of a monitoring group made up of coworkers who are likely to be familiar with the employee's choices and/or work product, as applicable in the particular context. When overseeing a decision maker, this group can also provide occasional advice to the decision maker as to the likely outcomes of his or her decisions (e.g., on an anonymous basis if the group or any of its members prefers to remain anonymous).

Preferably, each member of the monitoring group assesses whether or not the manager or other employee is free riding (e.g., in the context of the initial decision-making event regarding whether to pursue the project). If at least t out of the N members of the group detect free riding, then upper level management preferably decides whether or not to investigate and whether or not to impose a penalty, C, on the decision maker or other employee. This penalty, e.g., takes the form of an increased premium (e.g., for the present project or any future insurance), a reduction in the payout proceeds, a negative impact on the employee's ordinary compensation, and/or a negative performance evaluation.

In designing this monitoring mechanism, the insurance program 10 preferably selects a suitable threshold detection value. Consider the case where the insured is free riding. What is the chance that the provided mechanism will detect it? If each member of the monitoring group can detect such free riding with probability q, and assuming independent evaluations, the probability Q that this threshold is achieved is given by the upper tail of the binomial distribution:

$$Q ( t , q , N ) = {\sum }_{i = t}^{N} ( \begin{matrix}N \\ i\end{matrix} ) {( 1 - q )}^{N - i} {q}^{i} .$$

This equation gives the probability that the aggregated group estimates that the decision maker or other employee is free riding, thereby indicating a potential problem. On the other hand, there is the possibility of false positives, i.e., a member of the monitoring group detects free riding when there is none. Suppose this happens with probability q_{false}. Then the probability of a false positive for the group as a whole is Q_{false} given by the foregoing equation with q_{false} instead of q.

Preferably, a high threshold is selected in order to ensure that the formal mechanism rarely is exercised. At the same time, it is expected that the mere existence of the reporting system, together with the desire of the insured to maintain his or her professional reputation with his or her peer group, will promote dedication to delivering on the successful outcome of the selected project. Accordingly, with these features/choices, monitoring groups typically will be able to encourage correct behavior without having to act very often.

Also, it should be noted that penalties or sanctions need not follow directly from the insurance-related additional oversight 60. Instead, in alternate embodiments the information provided by additional oversight 60 is combined with other information in determining what consequences result.

In order to establish a group of individuals that can monitor and verify that the insured employee engages in behavior that is beneficial to the enterprise, it is preferable to identify those who have a familiarity both with the subject employee and also with the nature of the work that he or she engages in. Typically, those belonging to the employee's community of practice will have such familiarity. Accordingly, one strategy is to determine those communities of practice from the social network inside of organization 5. Such a monitoring group sometimes is referred to as a peer group of the insured individual. Members of the peer group preferably also have a familiarity with the particular project with respect to which insurance is being provided.

Preferably, e-mail communication patterns are used identify the employee's social network, from which is selected the group that provides oversight 60. One of the conventional techniques for analyzing e-mail patterns within an enterprise (without analyzing the contents of the messages) preferably is used for this purpose.

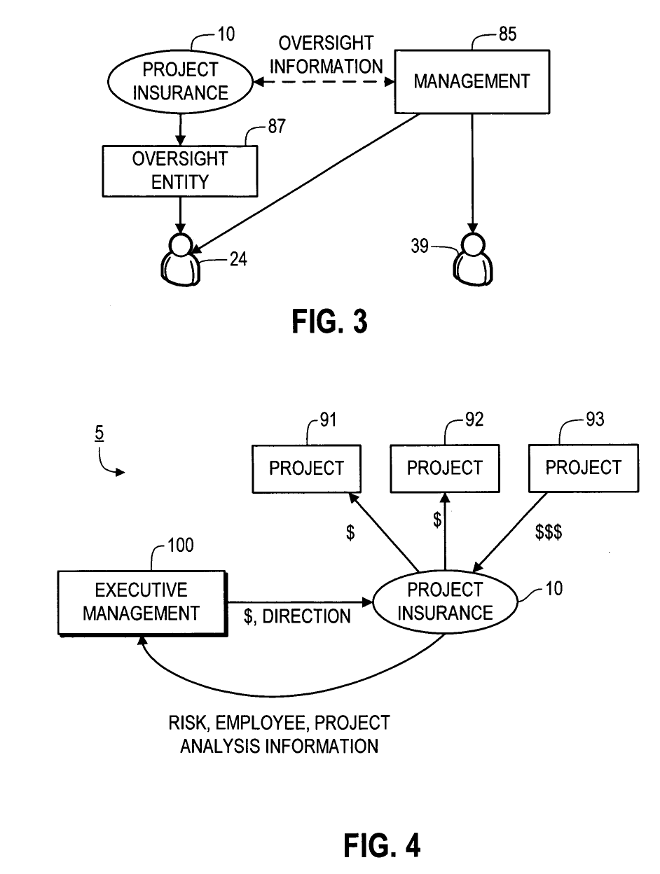

FIG. 3 is a block diagram illustrating certain examples of how the additional oversight employed in connection with the present project insurance is performed in accordance with a representative embodiment of the invention. In particular, FIG. 3 shows how the activities of two insured employees 24 and 39 are overseen in the present embodiment of the invention. First, the ordinary oversight by management 85 that otherwise would apply, even without the project insurance of the present invention, is maintained for both of employees 24 and 39 when such insurance is provided.

In addition, a separate oversight entity 87 provided by and/or under the control of project insurance program 10 also is used with respect to employee 24. Entity 87 preferably is the peer group for employee 24, as described above. It is noted that in certain embodiments of the invention oversight entity 87 actually consists of only a single person rather than a group.

Employee 39, on the other hand, continues to be overseen only by existing management 85, but with additional input and/or different and/or enhanced criteria provided by insurance program 10. In return, management 85 provides insurance program 10 with any reports of, and/or information about, potential free riding. The oversight structure with respect to employee 39 preferably is used for lower-level employees and in other situations that do not merit the establishment of a separate oversight entity 87 (e.g., where the provided insurance does not justify the costs of a separate oversight entity 87).

Returning to FIG. 2, in the present embodiment of the invention the information obtained from additional oversight 60 is made available for steps 55 and 59, discussed above. For instance, an employee who is found to have a substantial history of free riding preferably is declined project insurance for future projects in step 55. Similarly, the oversight information is used in step 59 to adjust premium amounts and payout proceeds for future project insurance obtained by the employee (e.g., increased premiums and/or lower payouts for employees having some evidence of past free riding, with the adjustments being based on the amount of previous free riding). In either event, such information preferably also is used, at least in certain circumstances, in step 59 with respect to the current project. For example, as noted above, a condition of the payout proceeds preferably is employee compliance with specified performance standards (e.g., no indication of free riding).

Still further, in the present embodiment the information obtained through the additional oversight 60 is provided 62 to management (e.g., executive management in the case of an insured manager). Such information preferably is used for making decisions regarding current and future projects, as well as for evaluating the insured employee, establishing his or her compensation and making other employment-related determinations (e.g., firings and transfers).

Next, in step 64 a determination is made as to whether or not the payout event defined in step 59 has occurred. As indicated above, in certain embodiments the event has multiple aspects to it. Preferably, at least one of such aspects due to failure to achieve at least one defined commercial success criterion. Another aspect preferably is evidence of adequate efforts (e.g., no substantial amount of free riding) by the insured on the subject project. The result of this determination preferably is provided to step 55 and 59 for a valuation in connection with those steps and also is provided 62 to executive management for use in overall strategic planning in the organization 5.

Finally, in step 65 the insurance proceeds are paid out if the payout event has been determined to have occurred. As noted above, in certain embodiments of the invention some (e.g., if there are multiple payout events and the premium is divided among them) or all of the insurance premium is deducted from the proceeds that otherwise would be payable (e.g., if the premium is not paid upfront).

The embodiments described above contemplate a cash payout. More generally, however, in the various embodiments of the invention different types of payout benefits are made in step 65. Such payout benefits include any or all of cash compensation, non-cash compensation (e.g., stock or stock options) and non-compensation benefits, such as promotions, assignments to other projects or a larger office. In the preferred embodiments, the available payout benefits are flexible enough to accommodate the needs and concerns of the employees, contractors or others who obtain project insurance, while simultaneously attempting to achieve the profit-maximization and other goals of the organization.

Although steps and 64 and 65 are shown in FIG. 2 as occurring at the end of the process, as noted above, the present invention also contemplates intermediate payments during the life of the project (i.e., while oversight 60 is ongoing). More generally, in certain embodiments of the invention steps 64 and 65 are repeated multiple times throughout the course of the project.

FIG. 4 is a block diagram illustrating relationships between the project insurance program 10 and other entities within the organization 5, from an overall organizational perspective, according to a representative embodiment of the present invention. As noted above, project insurance program 10 preferably operates on a profit-maximizing basis. Thus, program 10 evaluates the set of available projects 91-93 that are being undertaken or are contemplated to be undertaken by the organization 5, setting the premiums and payout proceeds in a manner so as to attempt to generate a net profit. In short, for each instance of insurance provided, preferably

$$P \geq OH + {\sum }_{i = 1}^{N} Pr ( {PE}_{i} ) * {PP}_{i} ,$$

where P is the premium amount, OH is the portion of the overhead of program 10 that is attributable to present insurance (although in certain embodiments the overhead is partially or completely subsidized by the overall organization 5), Pr(PEᵢ) is the probability of payout event i, PPᵢ is the payout proceeds for payout event i, and there are N possible payout events. Thus, the program 10 expects that it will payout proceeds for some of the projects (e.g., projects 91 and 92) for a net outflow, with the further expectation that it will receive premiums sufficient from the successful projects (e.g., project 93) that will more than offset such net outflow. Although some individual employees will find the risk associated with a given project to be unacceptable, the project insurance program 10 is better able to diversify away the risk from any individual project.

As noted above, in certain circumstances it will not be possible to provide insurance that both provides the correct incentives to the employee and also satisfies the foregoing minimum premium amount. Such a situation probably indicates that the employee's compensation package is not providing the correct incentives and therefore points to the need to consider revising it. However, if the organization 5 decides not to revise the employee's compensation package, or is unable to do it in a timely fashion, then with respect to the specific insurance that is then contemplated, organization 5 preferably provides cash incentives to program 10 to provide such insurance. These cash transfers should be feasible because the situation would tend to indicate that, based solely on the employee's general compensation package, the organization 5 is retaining a disproportionate amount of the profits from a successful risky project or, conversely, is overpaying the employee for successful non-risky projects.

Another significant benefit of establishing a project insurance program 10 according to the present invention, as indicated above, is the additional information that it spawns. As such, the project insurance program 10 preferably is an integral part of the overall management of the organization 5, providing valuable feedback for use in making strategic decisions. For instance, one of the main functions of program 10 is to evaluate the relative risks of different projects undertaken or proposed to be undertaken by the organization 5. Accordingly, it is uniquely situated to be one of the main sources of risk analysis information within the organization 5.

Moreover, the overall accuracy of the risk assessment information generally can be easily assessed by the organization 5. For example, if program 10 is operating at a profit, this generally would provide good preliminary evidence that it is doing a good job at evaluating risks and, accordingly, its risk assessments generally can be trusted by the organization 5. On the other hand, profitability might instead suggest that a significant number of employees are highly risk-averse and willing to pay high premiums for the offered project insurance, which possibility also clearly would validate the existence of program 10, but might suggest that profitability alone is not an accurate gauge of accuracy. Accordingly, a better indication of preferably is obtained by looking at the underlying projections that were used by program 10 in evaluating each individual project.

In any event, the risk information provided by program 10 preferably is used by executive management 100 in setting overall strategies for organization 5. In this regard, executive management 100 preferably attempts to maintain project risk within specified boundaries and to ensure that it is obtaining adequate additional returns for the additional risk that it is incurring (risk premiums). In view of these considerations and the information provided by program 10, better decisions often can be made regarding which projects to pursue and which to drop. Beyond overall risk assessment, the information from program 10 preferably is used for managing the risk profile of organization 5, e.g., for ensuring that the organization 5 is not overly exposed to risk in particular areas. For example, even if the overall risk assumed by the organization 5 is within acceptable boundaries, a disproportionate amount of that risk might be attributable to a single factor, e.g., a currency exchange fluctuations. The risk assessment information provided by program 10 preferably is used in any or all aspects of such risk management by organization 5.

In addition to providing risk information, program 10 preferably also provides to executive management 100 other information and analysis regarding the projects that it evaluates, and executive management 100 preferably uses such analysis and information in its decision-making processes. In this regard, program 10 can be viewed as a more or less independent layer of project evaluation. As such, in certain circumstances it will obtain and generate information and analysis that is different than other information and analysis generated within the organization 5.

Finally, as already indicated above, in the preferred embodiments of the invention program 10 implements mechanisms for obtaining additional information regarding the employees of organization 5. Such additional information preferably is provided to and then used by executive management 100 for performing employee reviews and for making strategic decisions in which an evaluation of its available personnel resources it is important.

In return, executive management 100 preferably provides other information that it has regarding the subject projects to program 10, for program 10 to evaluate in making its insurance-related decisions. In addition, executive management 100 preferably provides direction, e.g., regarding which programs to insure, in what areas the organization 5 is amenable to accepting additional risk, and in what areas organization 5 believe that it already is over exposed.

Thus, project insurance program 10 preferably is an integral part of the strategic and decision-making process with an organization 5, both sharing information and helping to effectuate the goals of organization 5.

System Environment.

Generally speaking, many or all of the methods and techniques described herein can be practiced with the use of a general-purpose computer system. Such a computer typically will include, for example, at least some of the following components interconnected with each other, e.g., via a common bus: one or more central processing units (CPUs), read-only memory (ROM), random access memory (RAM), input/output software and/or circuitry for interfacing with other devices and for connecting to one or more networks (which in turn, in many embodiments of the invention, connect to the Internet or to any other networks), a display (such as a cathode ray tube display, a liquid crystal display, an organic light-emitting display, a polymeric light-emitting display or any other thin-film display), other output devices (such as one or more speakers, a headphone set and/or a printer), one or more input devices (such as a mouse, touchpad, tablet, touch-sensitive display or other pointing device; a keyboard, a microphone and/or a scanner), a mass storage unit (such as a hard disk drive), a real-time clock, a removable storage read/write device (such as for reading from and/or writing to RAM, a magnetic disk, a magnetic tape, an opto-magnetic disk, an optical disk, or the like), and a modem (which also preferably connect to the Internet or to any other computer network via a dial-up connection). In operation, the process steps to implement the above methods, to the extent performed by such a general-purpose computer, typically initially will be stored in mass storage (e.g., the hard disk), are downloaded into RAM and then executed by the CPU out of RAM.

Suitable computers for use in implementing the present invention may be obtained from various vendors. Various types of computers, however, may be used depending upon the size and complexity of the tasks. Suitable computers include mainframe computers, multiprocessor computers, workstations, personal computers, and even smaller computers such as PDAs, wireless telephones or any other appliance or device, whether stand-alone, hard-wired into a network or wirelessly connected to a network. In addition, although a general-purpose computer system has been described above, in alternate embodiments a special-purpose computer instead (or in addition) is used. In particular, any of the functionality described above can be implemented in software, hardware, firmware or any combination of these, with the particular implementation being selected based on known engineering tradeoffs. In this regard, it is noted that the functionality described above primarily is implemented through fixed logical steps and therefore can be accomplished through programming (e.g., software or firmware), an appropriate arrangement of logic components (hardware) or any combination of the two, as is well-known in the art.

It should be understood that the present invention also relates to machine-readable media on which are stored program instructions for performing the methods of this invention. Such media include, by way of example, magnetic disks, magnetic tape, optically readable media such as CD ROMs and DVD ROMs, semiconductor memory such as PCMCIA cards, etc. In each case, the medium may take the form of a portable item such as a small disk, diskette, cassette, etc., or it may take the form of a relatively larger or immobile item such as a hard disk drive, ROM or RAM provided in a computer.

The foregoing description primarily emphasizes electronic computers. However, it should be understood that any other type of computer instead may be used, such as a computer utilizing any combination of electronic, optical, biological and/or chemical processing.

Additional Considerations.

In the discussion above, the focus primarily is on shifting direct compensation-related risk associated with certain projects away from managers and other employees and toward an insurance program that can better diversify such risks. Other than direct compensation effects, the insurance program 10 according to the present invention preferably also addresses effects that are not immediately direct, tangible or monetary, such as the risk of that the employee's professional reputation will suffer as a result of working for a significant amount of time on a project that ultimately ends in failure. In order to address these issues, the insurance according to one representative embodiment of the present invention includes non-monetary proceeds in the event that the payout event occurs. Such non-monetary proceeds preferably includes, e.g., guarantees of certain ratings in the employee's performance review. In addition, or instead, a component of insurance obtained through program 10 preferably includes a change in the way that the insured employee is reviewed (e.g., a change away from results-oriented criteria and toward criteria pertaining more to personal performance). Such change preferably automatically accompanies the provision of project insurance hereunder.

It is noted above that in certain embodiments of the invention the overall organization 5 provides cash transfers to program 10. Such transfers preferably are used to facilitate provision of insurance in circumstances where it otherwise would be difficult to provide. In addition, bonus transfers preferably also are given to subsidize the insurance in recognition of the fact that the company is making additional profits from projects that would not have occurred (or have attracted the appropriate talent to become successful) but for the provision of insurance by program 10.

In the preferred embodiments of the invention, project insurance program and is structured so as to be flexible from the employee's point of view. Preferably, this means that the employee can select whether to obtain insurance and/or even the amount of insurance to obtain.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A method of insuring decisions within an organization, comprising:
(a) providing project insurance to an individual working on a project for an organization, the project insurance having (i) a payout event that is defined as a failure of the project to meet a specified criterion pertaining to success of the project and (ii) an associated payout benefit; and
(b) providing the payout benefit to the individual under the project insurance in the event that the payout event occurs.

2. A method according to claim 1, wherein an amount of the payout benefit under the project insurance depends upon results of other projects undertaken by the organization.

3. A method according to claim 1, wherein the individual is assessed a premium for the project insurance.

4. A method according to claim 1, wherein provision of the project insurance triggers at least one of (i) additional oversight of, or (ii) additional criteria pertaining to, the individual.

5. A method according to claim 1, wherein the payout benefit provided to the individual under the project insurance is determined based on at least one of (i) actual current or (ii) anticipated future compensation of the individual.

6. A method according to claim 1, wherein provision of the project insurance triggers a change in criteria by which performance of the individual is evaluated.

7. A method according to claim 1, wherein the individual makes a decision whether to work on the project, and wherein the project insurance is offered to reduce risk to the individual as a result of said decision.

8. A method according to claim 7, further comprising a step of using a peer group to evaluate a quality of the decision.

9. A method according to claim 8, wherein the payout benefit is reduced if the peer group determines that the quality of the decision falls below a threshold decision quality.

10. A method according to claim 8, wherein the peer group is selected to include others that are familiar with the individual's professional qualifications and with the project.

11. A method according to claim 8, wherein the peer group is selected based on a level of community with the individual.

12. A method according to claim 11, wherein selection of the peer group includes analyzing organizational communication patterns between the individual and prospective members of the peer group.

13. A method according to claim 11, wherein selection of the peer group includes analyzing e-mail communication patterns between the individual and prospective members of the peer group.

14. A method according to claim 1, wherein the payout benefit is equal to a coverage benefit less a premium for the project insurance.

15. A method according to claim 1, wherein the individual has a compensation package that is reduced by a premium for the project insurance.

16. A method of insuring decisions within an organization, comprising:
(a) maintaining a project insurance program from which individuals within an organization may obtain project insurance covering any of a plurality of different projects undertaken by the organization on which said individuals participate, each said project insurance having (i) a payout event that is defined as a failure of a corresponding project to meet a specified criterion pertaining to success of the corresponding project and (ii) an associated payout benefit; and
(b) providing the associated payout benefits to the individuals covered under the project insurance when the applicable payout events occur.

17. A method according to claim 16, wherein the project insurance program assesses premiums and determines payout benefits in an attempt to create a net profit.

18. A method according to claim 17, wherein the organization provides additional funds to the project insurance program based on overall success rates of insured projects.

19. A method according to claim 16, wherein the project insurance program provides for additional oversight of efforts of the individuals who have obtained project insurance.

20. A method according to claim 16, wherein the project insurance program regularly provides project risk information to the organization.

21. A method according to claim 20, wherein the project risk information includes information regarding a number of individuals requesting insurance for a particular project.

22. A method according to claim 16, wherein the organization provides parameters regarding acceptable risk levels to the project insurance program.

23. A method according to claim 16, wherein the payout benefit provided to an individual under the project insurance are determined based on at least one of (i) actual current or (ii) anticipated future compensation of the individual.

24. A method according to claim 16, wherein an amount of the payout benefit under the project insurance depends upon results of other projects undertaken by the organization.

25. An apparatus for insuring decisions within an organization, comprising:
means for providing project insurance to an individual working on a project for an organization, the project insurance having a payout event that is defined as a failure of the project to meet a specified criterion pertaining to success of the project and an associated payout benefit; and
means for providing the payout benefit to the individual under the project insurance in the event that the payout event occurs.

26. A computer-readable medium storing computer-executable process steps for insuring decisions within an organization, said process steps comprising steps of:
providing project insurance to an individual working on a project for an organization, the project insurance having a payout event that is defined as a failure of the project to meet a specified criterion pertaining to success of the project and an associated payout benefit; and
providing the payout benefit to the individual under the project insurance in the event that the payout event occurs.

27. A method of insuring decisions within an organization, comprising:
(a) maintaining a project insurance program from which individuals within an organization who make decisions about which projects they work on may obtain project insurance to reduce risk to the individuals as a result of said decisions, each said project insurance having (i) a payout event that is defined as a failure of a corresponding project to meet a specified criterion pertaining to success of the corresponding project and (ii) an associated payout benefit;
(b) using a peer group to evaluate a quality of the decisions made by the individuals who have obtained the project insurance; and
(c) providing the associated payout benefits to the individuals covered under the project insurance when the applicable payout events occur,
wherein the payout benefit is reduced if the peer group determines that the quality of the decision falls below a threshold decision quality.
